(19) United States
(12) Patent Application Publication
(10) Pub. No.: US 2007/0224481 A1
(43) Pub. Date: Sep. 27, 2007

(54) MANIFOLD AND STACK OF ELECTROCHEMICAL REACTOR CELLS, AND ELECTROCHEMICAL REACTOR SYSTEM COMPOSED OF THESE COMPONENTS

(75) Inventors: Toshio SUZUKI, Aichi (JP); Toshiaki Yamaguchi, Aichi (JP); Yoshinobu Fujishiro, Aichi (JP); Masanobu Awano, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst of Adv Industrial Science and Tech., Chiyoda-ku (JP)

(21) Appl. No.: 11/691,030

(22) Filed: Mar. 26, 2007

(30) Foreign Application Priority Data
Mar. 27, 2006 (JP) 2006-085556

(51) Int. Cl. H01M 8/12; H01M 8/24

(52) U.S. Cl. 429/31; 429/32; 429/38

(57) ABSTRACT

The present invention provides a smaller and more efficient tube-type electrochemical reactor cell stack, along with an electrochemical reactor system using this stack, and the invention provides an electrochemical reactor cell stack which is a structure comprising electrochemical reactor cells with a tube structure composed of an anode (fuel electrode), a dense ion conductor (electrolyte) and a cathode (air electrode) arranged in connecting holes on the side of a fuel gas pipe, wherein each tube-type cell is connected in parallel or series electrically by means of a conduction connector, along with a manifold for tube-type cells and an electrochemical reactor system using it, and the use of a manifold and stack structure with high industrial productivity allows the small tube-type cells to be highly integrated, so that a highly efficient solid oxide fuel cell or other electrochemical reactor system can be provided.

### TECHNICAL FIELD

The present invention relates to an electrochemical reactor cell stack and to a solid oxide fuel cell or other electrochemical reactor system composed of this reactor cell stack, and relates more specifically to a tube-type electrochemical reactor cell stack and electrochemical reaction system wherein the output per unit volume is dramatically increased by means of a stacking method which optimizes the arrangement of electrochemical reactor cells, and through the use of a manifold with excellent industrial productivity. The present invention provides a technology for constructing a microreactor cell stack structure using technology for miniaturizing tube-type reactor cells and manifold technology which simultaneously provides a more efficient arrangement of these smaller cells and a more compact structure for introducing and exhausting a fuel gas, and thereby provides an electrochemical reactor cell stack that can be used favorably as a clean energy source and environmental purification device, as well as new technologies and new products for electrochemical reactor systems using this reactor cell stack.

### BACKGROUND ART

A typical electrochemical reactor is the solid oxide fuel cell (hereunder abbreviated as “SOFC”). An SOFC is a fuel cell that uses an ion-conductive solid oxide electrolyte as the electrolyte. The basic SOFC structure is normally composed of three layers, a cathode (air electrode), a solid acid electrolyte and an anode (fuel electrode), and is normally used at a temperature range of 800 to 1000° C.

When fuel gas (oxygen, carbon monoxide, hydrocarbons, etc.) is supplied to the anode of an SOFC and air, oxygen or the like is supplied to the cathode, a difference occurs between the oxygen partial pressure of the cathode and the oxygen partial pressure of the anode, and voltage occurs between the electrodes in accordance with Nernst's equation. The oxygen converts to ions at the cathode and moves to the anode inside the solid electrolyte, and the oxygen ions arriving at the anode react with the fuel gas and release electrons. As a result, if loads are attached to the anode and cathode electricity can be directly extracted from the fuel cell.

To make the SOFC more practical it will be necessary to lower its operating temperature, and it is thought that an effective way of achieving this is by forming the electrolyte as a thin film and using a fuel with high ion conductivity. Because using a support made of electrode material allows the electrolyte to be formed as a thin film, anode support-type cells are being widely studied. If the operating temperature could be lowered to 500 to 600° C., cheaper materials could be used and operating costs reduced, increasing the flexibility of SOFCs. Flat SOFCs have already been proposed which achieve high electrical power output (0.8 to 1 W/cm²) at a low temperature (600° C.) through the use of new anode and cathode materials (Z. Shao and S. M. Haile, Nature 431, 170-173 (2004); T. Hibino, A. Hashimoto, K. Asano, M. Yano, M. Suzuki and M. Sano, Eletrochem. Solid-State Lett., 5(11), A242-A244 (2002)).

However the anode support-type SOFCs with high electrical power output that have been reported so far are of the flat type, and are liable to cell failure under rapid operating cycle conditions. Cell failure occurs when the commonly used nickel cermet undergoes large volume changes due to temperature changes and cycling in an oxygen-reduction atmosphere, resulting in cell deformation. An extremely important technical issue is therefore to find a way of enlarging and stacking flat cells while maintaining their properties. Controlling the electrode structure of the anode support substrate and making it thinner are important ways of improving the properties, but it has been difficult to decrease the thickness and increase the porosity of flat types. SOFC structures consisting of tubular cells have been studied to replace flat cells (Japanese Patent Application Laid-open No. 2004-335277).

The tube cell stacks proposed so far have a structure in which the tube cells are stably held by the cathode material, but the problem is that as the diameter of the tubes is reduced the tube-shaped cells become more difficult to pack, and no specific means such as a manifold has been proposed for this. At present, moreover, no highly efficient small tube cells or efficiently integrated stack of such tube cells has been reported using conventional materials, and with the integrated structures of tube cells currently being proposed it is difficult to ensure an air gas route, and large quantities of expensive cathode materials have to be used.

### DISCLOSURE OF THE INVENTION

Under these circumstances and in light of the prior art described above, the inventors discovered as a result of exhaustive research aimed at developing an SOFC and new use therefor that would finally resolve the aforementioned problems of conventional parts that a manifold and stacking method could be provided for efficiently arranging tube-type cells with fine diameters, and that an electrochemical reactor system capable of operating at lower temperatures could be provided using this stack, and they perfected the present invention after further research based on these new findings.

That is, it is an object of the present invention to provide a manifold and stack capable of efficiently integrating tube-type electrochemical reactor cells having a cell structure suited to low-temperature operations. It is also an object of the present invention to construct a cell stack that allows easy integration and ensures adequate air passage, and to provide a cell stack wherein serial and parallel connections can be constructed as desired within the stack. Moreover, it is another object of the present invention to provide a cell stack structure whereby the generated voltage of the unit stack can be increased while using smaller amounts of the cathode materials which are required in conventional tube-type cell modules and reducing manufacturing costs. It is also an object of the present invention to provide a solid oxide fuel cell or other electrochemical reactor system using this tube-type electrochemical reactor cell stack.

To resolve these issues, the present invention comprises the following technical means.

(1) An electrochemical reactor cell stack comprising a tube structure composed of an anode (fuel electrode), a dense ion conductor (electrolyte) and a cathode (air electrode), wherein 1) tube-type cells are arranged on a connecting part for connection located in the side of a fuel gas pipe, and 2) the respective tube-type cells are connected in parallel or series electrically.

(2) The electrochemical reactor cell stack according to (1) above, wherein the tube-type cells are arranged on the connecting part of a manifold having a fuel gas introduction part, a fuel gas exhaust part and a connecting part for supporting the tube structure formed as a single unit.

(3) The electrochemical reactor cell stack according to (2) above, wherein the manifold is made of a metal material.

(4) The electrochemical reactor cell stack according to (2) above, wherein the manifold is made of a ceramic material.

(5) The electrochemical reactor cell stack according to (2) above, wherein the respective tube-type cells are arranged so as to be connected in parallel or series electrically to the manifold.

(6) The electrochemical reactor cell stack according to (2) above, wherein a gas conduit with an introduction part and exhaust part for the fuel gas is formed by stacking adjacent manifolds.

(7) A manifold for an electrochemical reactor cell stack comprising a tube structure composed of an anode (fuel electrode), a dense ion conductor (electrolyte) and a cathode (air electrode), wherein a fuel gas introduction part, a fuel gas exhaust part and a connecting part for supporting the tube structure are formed as a single unit.

(8) An electrochemical reactor cell stack module comprising the manifolds according to (3) above stacked with insulating sheets therebetween, wherein each manifold is connected by means of a connector.

(9) An electrochemical reactor stack module comprising the manifolds according to (4) above stacked, wherein each manifold is connected by means of a connector.

(10) An electrochemical reactor system for deriving current from an electrochemical reaction comprising the electrochemical reactor cell stack according to any one of (1) through (6) above, wherein the reactor system has an operating temperature of 650° C. or less.

(11) The electrochemical reactor system according to (10) above, wherein the electrochemical reactor system is an electrochemical reactor for a solid oxide fuel cell or for waste gas purification, hydrogen production or synthetic gas production.

The present invention is explained in more detail below.

The electrochemical reactor cell stack structure of the present invention has a structure in which adjacent tubes attached to a fitting in the side of a fuel gas introduction part are connected in parallel or series electrically, and the manifold for the electrochemical reactor cells supports the fine-diameter tube-type cells with the fuel gas introduction part and exhaust part form a single unit.

Conventionally, tube-type SOFC structures have had a tube diameter of 5 mm to a few cm, and various methods have been proposed for stacking these tubes. In the case of microtube-type cells with diameters of a few mm or less, however, no effective cells have been reported, and since it would be difficult to integrate microtube-type cells with diameters of a few mm using conventional methods, there have been no reports of efficient integrated cell stacks. With the method of constructing a manifold or stack of the present invention, however, it is possible to construct a stack with a minimum volume and any voltage output, thereby providing a highly efficient tube-type cell stack, and an electrochemical system capable of operating at lower temperatures can be obtained using this cell stack.

In the present invention, using a manifold with both an efficient arrangement of tube-type cells and compact fuel gas introduction and exhaust parts allows the use to widely-used industrial processes, and a consequent reduction in manufacturing costs. Examples of electrochemical reactor systems of the present invention using this tube-type electrochemical reactor cell stack include solid oxide fuel cells (SOFC), waste gas purification electrochemical reactors and hydrogen producing reactors. With the present invention, a highly efficient electrochemical reactor system can be constructed using this electrochemical reactor cell stack.

Next, a tube-type electrochemical reactor of one embodiment of the present invention and an electrochemical reactor system constructed from this reactor are explained in detail. First, the make-up of a tube-type electrochemical reactor cell of the present invention is explained. FIG. 1 is a simplified view of a tube-type electrochemical reactor cell of the present invention. As shown in FIG. 1, dense solid electrolyte layer 1 is formed on anode tube 2, which is composed of a porous ceramic hollow tube. Cathode 4 is placed on the outside of electrolyte layer 1, thereby constructing a tube-type electrochemical reactor cell having tube hole 3 and exposed anode part 5.

Electrolyte layer 1 is explained first. When determining the thickness of electrolyte layer 1, the diameter of the porous tube, the specific resistance of solid electrolyte layer 1 itself and the like need to be taken into consideration. Electrolyte layer 1 is dense, with a thickness preferably in the range of 1 to 100 microns, or preferably 50 microns or less in order to control the electrical resistance of the electrolyte. It is easy to reduce the thickness because the electrolyte is layered on the surface of anode tube 2. Under normal use conditions for a fuel cells, hydrogen, carbon monoxide, methane or other fuel gas is supplied to tube hole 3, while air, oxygen or other oxidizing gas is supplied to the outside of this tube.

The tube-type electrochemical reactor cell of the present invention preferably has a tube thickness of 0.5 mm or less and a diameter of 2 mm or less. Favorable anode electrode properties can be obtained with a tube thickness of 0.5 mm or less. By keeping the tube diameter at 2 mm or less, moreover, it is possible to achieve a tube structure with a highly porous electrode structure while maintaining strength even with a tube thickness of 0.5 mm or less. For purposes of cell stack preparation the tube length is not particularly limited, and can be designed at will to obtain the necessary anode properties while considering the overall size of the required electrochemical microcell reactor. For purposes of rapid gas diffusion and promoting reduction reactions, the porosity of the tube is preferably 10% or more.

The electrolyte material used must be one that provides high ion conduction, and desirable examples of such materials include oxide compounds comprising 2 or more elements selected from Zr, Ce, Mg, Sc, Ti, Al, Y, Ca, Gd, Sm, Ba, La, Sr, Ga, Bi, Nb and W.

Of these, preferred examples include zirconia stabilized with stabilizers such as yttria (Y₂O₃), calcia (CaO), scandia (Sc₂O₃), magnesia (MgO), ytterbia (Yb₂O₃), erbia (Er₂O₃) and the like, and ceria (CeO₂) doped with yttria (Y₂O₃), gadolinia (Gd₂O₃), samaria (Sm₂O₃) and the like. Stabilized zirconia is preferably stabilized with one or two or more stabilizers.

Specific examples preferably include yttria-stabilized zirconia (YSZ) stabilized with 5 to 10 mol % of yttria as a stabilizer, gadolinia-doped ceria (GDC) with 5 to 10 mol % of gadolinia added as a dopant and the like. In the case of YSZ for example, an yttria content of less than 5 mol % is undesirable because the oxygen ion conductivity of the anode is adversely affected. Similarly, an yttria content of more than 10 mol % is also undesirable because the oxygen ion conductivity of the anode is adversely affected. The same applies to GDC.

The tube is preferably a complex composed of a mixture of anode material and electrolyte material. The anode material is a metal selected from Ni, Cu, Pt, Pd, Au, Ru, Co, La, Sr and Ti and/or an oxide comprising 1 or more of these elements, and since it functions as a catalyst, desirable examples include nickel (Ni), cobalt (Co), ruthenium (Ru) and the like. Of these, nickel (Ni) can be used by preference because it is cheaper than other metals and has sufficient reactivity with hydrogen and other fuel gasses. It is also possible to use a complex obtained by mixing these elements and oxides.

In the complex of an anode material and an electrolyte, the ratio of the first to the second is preferably in the range of 90:10 wt % to 40:60 wt %, or preferably 80:20 wt % to 45:55 wt % from the standpoint of balance including compatibility of the electrode activity and thermal expansion coefficient. The cathode material is preferably a material with high oxygen ionization activity, and a material composed of 1 or more of the elements Ag, La, Sr, Mn, Co, Fe, Sm, Ca, Ba, Ni and Mg and oxide compounds of these is particularly desirable.

Of these, a transitional metal perovskite oxide or a complex of a transitional metal perovskite oxide and an electrolyte material can be used by preference. Of the necessary properties of the cathode (electron conductivity and oxygen ion conductivity), oxygen ion conductivity is improved when using a complex, so that oxygen ions generated in the cathode move more easily into the electrolyte layer, thereby enhancing the electrode activity of the cathode.

When using a complex of a transitional metal perovskite oxide and a solid electrolyte material, the ratio of the first to the second is preferably in the range of 90:10 wt % to 60:40 wt % or preferably 90:10 wt % to 70:30 wt % from the standpoint of balance including compatibility of the electrode activity and thermal expansion coefficient.

Desirable examples of transitional metal perovskite oxides include such composite oxides as LaSrMnO₃, LaCaMnO₃, LaMgMnO₃, LaSrCoO₃, LaCaCoO₃, LaSrFeO₃, LaSrCoFeO₃, LaSrNiO₃ and SmSrCoO₃.

However, as shown in FIG. 1, at one end of anode tube 2 part of the tube is not covered by electrolyte layer 1, thereby forming exposed anode part 5 at one end of anode tube 2. This exposed anode part 5 functions as the external lead electrode of the anode. The exposed area of this exposed anode part 2 is not particularly limited, and can be adjusted appropriately considering the gas seal member, the electrode current collection method, the gas outlet path and the like.

Next, the method of configuring the tube-type electrochemical reactor cells of the present invention as an SOFC stack is explained. As shown in FIGS. 2 and 3 the ends of the anode tubes are arranged on fuel introduction pipe 6, and both ends of the anode tubes are sealed inside fuel introduction pipe 6 by sealant 7. In this case, part of exposed anode part 5 must be exposed on the outside of fuel introduction pipe 6.

That is, the tube-type electrochemical reactor cells are mounted inside fuel introduction pipe 6, and each electrode connection is sealed by means of sealant 7. The material of sealant 7 is not particularly limited as long as it does not allow gas permeation. However, it must be compatible with the thermal expansion coefficient of the anode part. Specifically, desirable examples include mica glass, spinel (MgAl₂O₄) and other ceramics and the like, but brazing metal can also be used for sealing.

Conduction connectors 8 are also attached to the electrode surfaces (exposed anode part and cathode). Lanthanum chromite (LaCrO₃) and other conductive ceramics, gold, silver, platinum and other precious metals, and stainless steel, nickel and the like for example are desirable as the principal material making up conduction connectors 8. The connectors can be attached by applying these materials in paste form and sintering. When a brazing metal is used as the seal material, it can also be used as the connector material for electrically connecting the tubes.

The material of fuel introduction pipe 6 may be any electrically insulating material, without any particular limitations. Specifically, desirable examples include materials composed of one or more selected from the elements Al, Mg, Si, Ca and the like and oxide compounds of these. The introduction pipe is preferably in a tube shape but may also be rectangular or oval, without any particular limitations.

As shown in FIG. 2, when the tube-type cells are connected in parallel each unit has a voltage output of about 1 V. This easily permits a serial connection for battery purposes when the units are stacked by attaching conduction connectors 8 as shown by Type A and Type B in FIG. 2. Any degree of integration can be easily achieved using these units according to the purpose of use.

FIG. 3 shows a method of integrating the units with the tube cells arranged parallel to one another. The conduction connectors are positioned on the fuel introduction pipes so that a serial connection is formed when the units connected, allowing the construction of a stacked module having a voltage output of 1 V×the number of stages.

As shown in FIG. 4, however, when the tube cells are connected serially a voltage output of 1 V times the number of tubes is obtained with a single unit. In this case, the desired voltage output can be designed while minimizing the volume used, which is desirable for application to small consumer electric devices.

A single operation method in which a tube-type electrochemical reactor of the present invention is operated as a single unit as a SOFC is explained above, but the present invention is not limited to this operating method.

Moreover, as shown in FIG. 5, electricity can be generated by using an oxidizing gas or fuel gas introduction means (such as an external manifold) to introduce fuel gas into the anode tubes, and connecting load 12 via current collection wires 13. The flow volume of fuel gas in a tube-type electrochemical reactor cell is determined appropriately out of considerations of fuel efficiency.

Next, a manifold in which these tube-type electrochemical reactor cells of the present invention can be efficiently arranged is explained. As shown in FIG. 6, manifold 14a has a structure in which tube cells 9 are held with fuel gas inlet 10 of the fuel gas introduction part and fuel gas outlet 11 of the exhaust part formed as a single unit. The tube-type cells here are fixed by means of the aforementioned sealant 7.

The manifold material is not particularly limited as long as it can withstand the operating temperature of the electrochemical reactor, but ceramics and stainless steel are particularly desirable. The method of preparing the manifold is not limited, and can be a preparation method using computer-controlled cutting or micro-casting for example.

The manifold of the present invention is composed of a part for holding the tube cells and parts for introducing and exhausting the fuel gas. The fuel gas introduction part can be configured in various ways, without any particular limitations, but it is desirable to arrange it either alongside manifold 14a as shown in FIG. 6 or vertically with respect to manifold 14b as shown in FIG. 7 for example. As shown in the figures, the gas introduction and exhaust parts are open in each manifold, and these are integrated to complete the gas conduit.

In FIG. 6, tube cells 9 are arranged in parallel, allowing them to be electrically connected in an array to the conduction connector. In the case of such an array, the manifold material may be a non-conductive or conductive material such as ceramics or stainless steel. When the tube-type cells are arranged in opposite directions as in FIG. 7, however, the adjacent cell terminals can be serially connected by connecting them to the conductive connector. In this case, the manifold material must be a non-conductive material, such as alumina or another ceramic material.

The manifold having gas introduction and exhaust parts of the present invention is also effective when integrated with other manifolds. FIG. 8 shows an integrated sequence of the manifolds shown in FIG. 6. The fuel gas inlets and outlets are arranged in the same direction, making it easy to introduce the fuel gas. When the manifolds are made of an electrically conductive material such as stainless steel, moreover, the manifolds can be electrically insulated from one another by placing insulating sheets 17 of glass or the like between the stacked manifolds as shown in FIG. 9, allowing for a serial electrical array of manifold units.

As shown in FIGS. 9 and 10, the integrated manifolds can be used as a cell stack if seal plate 15 is placed either above or below the stack to terminate the fuel gas conduit. There are no particular limitations on the seal plate 15 used here, but it is preferably of the same material as the manifold. Seal plate 15 can be easily attached and fixed by means of glass paste or the like.

Next, the operations of the stacking method and manifold for tube-type electrochemical reactor cells of the present invention are explained. The tube-type electrochemical reactor cell stack of the present invention has tube-type cells connected to a fuel gas introduction pipe and connected in parallel or series via a conductive connector, or else uses a manifold in which the fuel gas introduction and exhaust parts and the part holding the tube-type cells are made as a single unit.

Up till now it has been difficult to achieve an efficiently integrated cell stack of high-performance cells with a tube diameter of a few mm or less. However, which the configuration of the aforementioned tube-type electrochemical reactor cell stack is possible to construct a stack suited to the purpose of use, and to construct and provide a small electrochemical reactor system with improved power output per unit volume.

Next, desirable methods for manufacturing the tube-type electrochemical reactor cells and stack of the present invention are explained. The method of manufacturing the tube-type electrochemical reactor cell of the present invention basically comprises steps such as the following:

(1) A step of mixing an anode material, a cellulose polymer and water, and extrusion molding the mixture to form a molded tube which is then dried or pre-baked;

(2) A step of coating the resulting molded tube with a slurry obtained by mixing an electrolyte material, an organic polymer and a solvent, and then simultaneously baking the anode tube structure and electrolyte at 1300 to 1600° C.;

(3) A step of coating the resulting ion conductor-coated porous tube structure with a cathode material, and baking at 800 to 1300° C.

These steps are explained in detail below.

First, the anode tube is prepared using a mixture of an anode material and an electrolyte material. Specifically, a binder is added to a powder of an oxide compound comprising 2 or more elements selected from Zr, Ce, Mg, Sc, Ti, Al, Y, Ca, Gd, Sm, Ba, La, Sr, Ga, Bi, Nb and W and a powder of a metal element or oxide selected from Ni, Cu, Pt, Pd, Au, Ru, Co, La, Sr and Ti, and this is kneaded with water and the resulting plastic mixture is molded into a molded tube of the specified diameter, length and tube thickness by extrusion molding or the like.

A cellulose organic polymer must be used in this step. The binder should be used in the amount of 5 to 50 g or preferably 10 to 30 g of cellulose organic polymer per 100 g of anode material. A carbon powder or other pore-producing agent may also be added as necessary. The resulting tube is dried at room temperature and may also be pre-baked at up to 1000° C. as necessary. An anode tube with a porosity of 10% or more after baking can be obtained in this way.

Next, an electrolyte material powder is made to adhere to the resulting molded tube, and dried. The electrolyte slurry is prepared for example by mixing an electrolyte material powder, an organic polymer and a solvent or the like. It is desirable to use a vinyl polymer as the organic polymer. A dispersion agent can also be added as necessary. The coating thickness can be controlled by controlling the slurry concentration with an organic compound such as alcohol, acetone, toluene or the like as the solvent. By this means, an electrolyte layer-forming layer which will become the solid electrolyte layer when baked is made to adhere to the surface of the tube. The drying method is not particularly limited, and appropriate methods and means can be used.

One example of a desirable method for applying the slurry is a dip coating method in which both ends of the anode tube are first sealed with a resin or other adhesive, and the tube is then dipped in slurry comprising a solid electrolyte. Various methods other than dipping can be used, however, such as brush painting, spraying and the like.

At this point, an exposed anode part where part of the anode is exposed without being covered by the slurry comprising the solid electrolyte needs to be formed on the outside surface of one end of the tube with the electrolyte layer. An electrolyte-coated structure is obtained by baking this at the desired temperature. This structure is preferably baked at a temperature of about 1200 to 1600° C., but this is not a limitation, and the baking temperature can be set appropriately depending on the tube material, porosity and the like so as to achieve a dense electrolyte layer. The tube length is not particularly limited, and can be determined appropriately according to the designed stack shape.

Next, the cathode material is applied to the electrolyte layer. The material is preferably composed of 1 or more of Ag, La, Sr, Mn, Co, Fe, Sm, Ca or oxide compounds of these. A slurry is prepared from this powder, and a cathode is formed on the electrolyte layer using methods similar to those used to prepare the aforementioned solid electrolyte.

Next, the resulting tube is baked at a specified temperature to obtain a tube-type electrochemical reactor cell. The baking temperature is preferably about 800 to 1200° C. but is not limited thereto, and can be adjusted according to the type of cathode material and the like.

A tube-type electrochemical reactor cell is thus obtained having cathode 3 layered on the outside of the electrolyte layer of an electrolyte-coated anode tube formed by attaching solid electrolyte layer 1 to the outside of anode tube 2.

The cathode or anode part of the resulting tube-type electrochemical reactor cell can also be machined as necessary to adjust the figuring or dimensions. Because the anode part needs to be exposed at one end of the tube-type cell after connection to the fuel gas introduction pipe, the length of the cathode or electrolyte can be determined appropriately considering the length of the exposed anode part, but these are not particularly limited.

Next, the procedures for stacking these tube-type electrochemical reactor cells are explained. The stack is generally prepared as follows when using a fuel gas introduction pipe.

(1) The necessary number of tube-type cell attachment holes is provided in a fuel gas introduction pipe, which is sealed at one end.

(2) The cells are arranged with the exposed anode parts at the same end in the case of a parallel connection or with the exposed anode parts at opposite ends in the case of a serial connection, and fixed with a sealant.

(3) The conductive connector is attached. In this case, metal paste is applied for example so that adjacent tubes are electrically connected.

(4) A conductive connector or the like is applied on the cathode with metal paste or the like.

The size of the gaps between holes in the fuel gas introduction pipe is not particularly limited but is preferably as small as possible. As shown in FIG. 3, a stack can be formed having a serial or parallel arrangement of tubes with each structure attached to a common fuel gas introduction part.

These can also be stacked and the manifolds connected at the anode side via interconnects or the like to a cathode collector one stage above to thereby construct an electrochemical reactor capable of multi-volt generation.

Using the manifold of the present invention, a variety of stacks can be constructed and prepared as desired according to the purpose and materials as shown in FIGS. 8 to 10. Of these, a stack is prepared as follows in the case of FIG. 8 for example.

(1) The cells are arranged with the exposed anode parts at the same end, and fixed with a sealant.

(2) Conduction connectors are attached to the anode and cathode ends. For this purpose, metal paste for example is applied so that adjacent tubes are electrically connected.

(3) The manifolds are stacked and fixed with glass or ceramic bond or the like to create a fuel gas seal. At this stage, the manifolds are electrically connected as necessary by means of connectors at the anode and cathode ends.

(4) A seal plate is attached to the topmost manifold of the stack to create a gas seal.

A stack using the manifold of the present invention can take a variety of forms and is not limited to the form shown here, and a variety of forms of manifolds having gas introduction parts, exhaust parts and tube-type cell-holding parts can be prepared and used to make stacks.

The following effects are provided by the present invention.

(1) Providing a tube-type electrochemical reactor cell stack with a more efficient arrangement of cells that makes them structurally more easy to stack, so that module voltage per volume can be increased by serially connecting these stacked cells, thereby providing a ceramic reactor with an extremely high electrical output even at low capacity;

(2) Providing a high-performance electrochemical reactor the manufacturing costs of which can be reduced through the use of a manifold having both an efficient tube cell arrangement and compact fuel gas introduction and exhaust parts, thereby allowing for the application of widely-used industrial processes;

(3) Providing an electrochemical reactor with excellent cost performance because only the necessary amount of cathode material needs to be applied to the electrolyte layer of the tube in the aforementioned configuration;

(4) Providing a solid oxide fuel cell or other electrochemical reactor system using the aforementioned tube-type electrochemical ceramic reactor cell stack which can be operated at 650° C. or less;

(5) The electrochemical reactor system of the present invention can be used favorable as a clean energy source or environmental purification device; and

(6) Allowing a large increase in surface area per unit volume by reducing the tube size and the thickness of the electrolyte, thereby achieving even lower operating temperatures.

### BRIEF DESCRIPTION OF THE DRAWINGS

FIG. 1 is a rough view of a tube-type electrochemical reactor cell of the present invention;

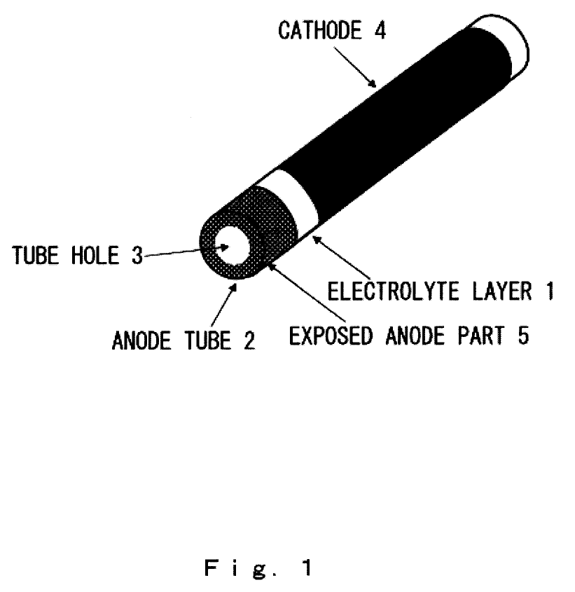

FIG. 2 shows a sample configuration of a tube-type electrochemical reactor cell stack (parallel type) of the present invention;

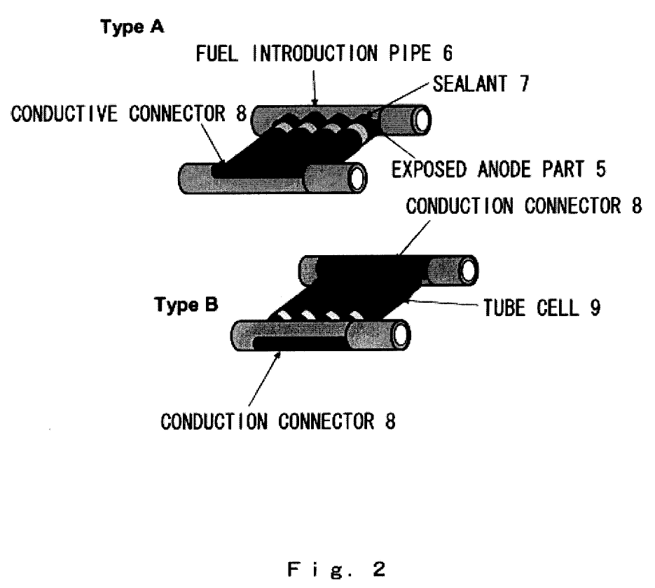

FIG. 3 shows a sample configuration of serially connected tube-type electrochemical reactor cell stacks (parallel type) of the present invention;

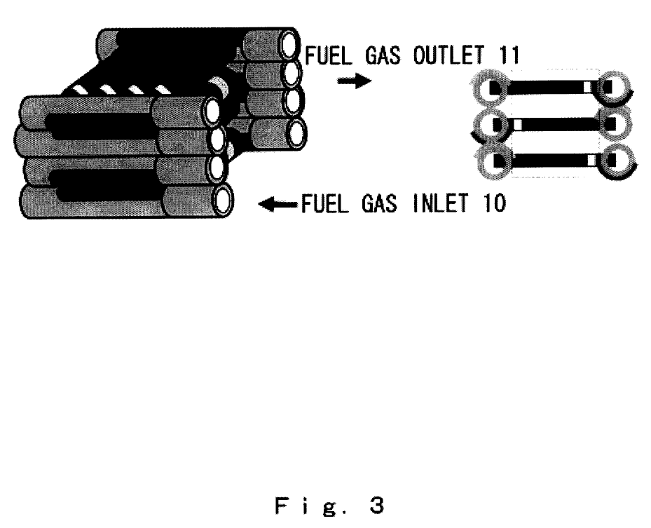

FIG. 4 shows a sample configuration of a tube-type electrochemical reactor cell stack (serial type) of the present invention;

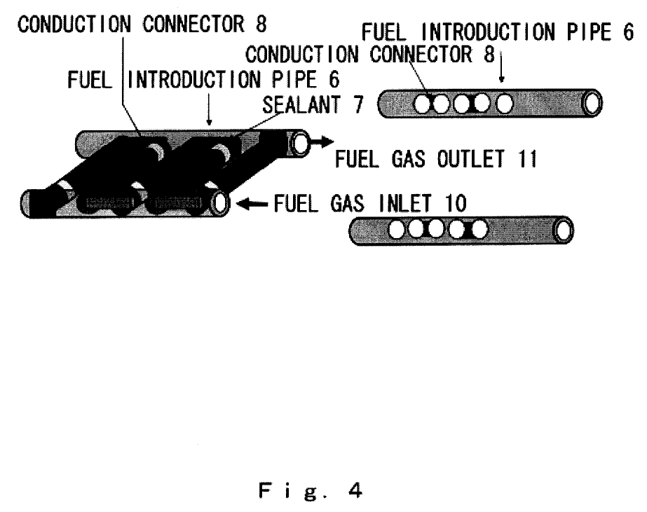

FIG. 5 shows an example of a tube-tube electrochemical reactor cell stack (serial type) used as a fuel cell;

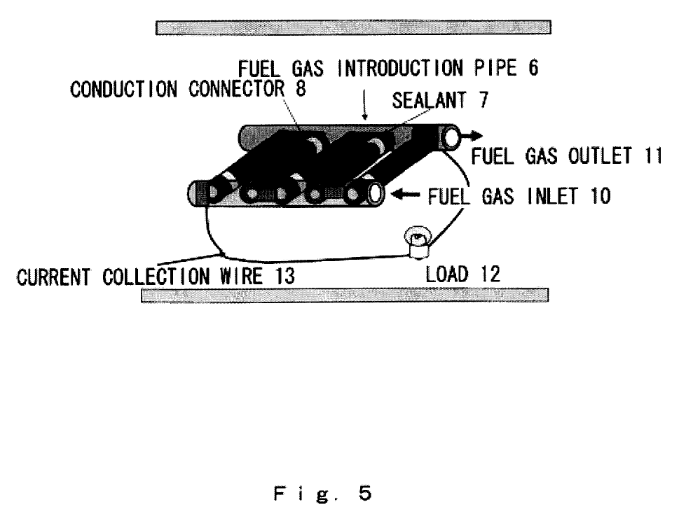

FIG. 6 shows a manifold of the present invention in which the fuel gas introduction and exhaust parts and the structure holding the tube-type cells are formed as a unit. The gas passages are located at the sides of the manifold;

FIG. 7 shows a manifold of the present invention in which the fuel gas introduction and exhaust parts and the structure holding the tube-type cells are formed as a unit. The gas passages are located at the top and bottom of the manifold;

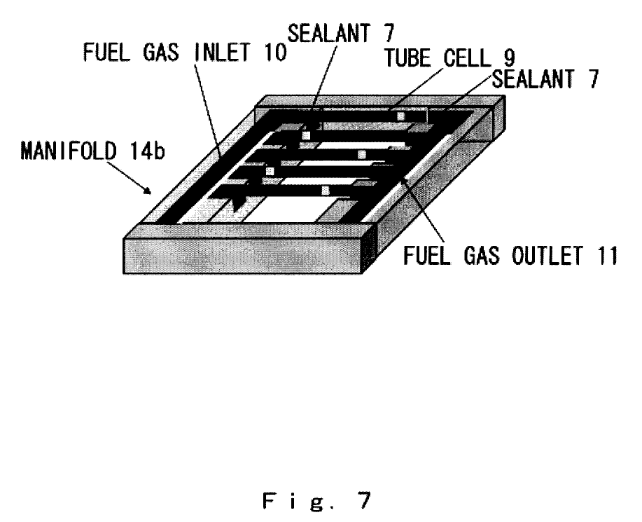

FIG. 8 shows an example of stacking using the manifold shown in FIG. 6 (ceramic or other material);

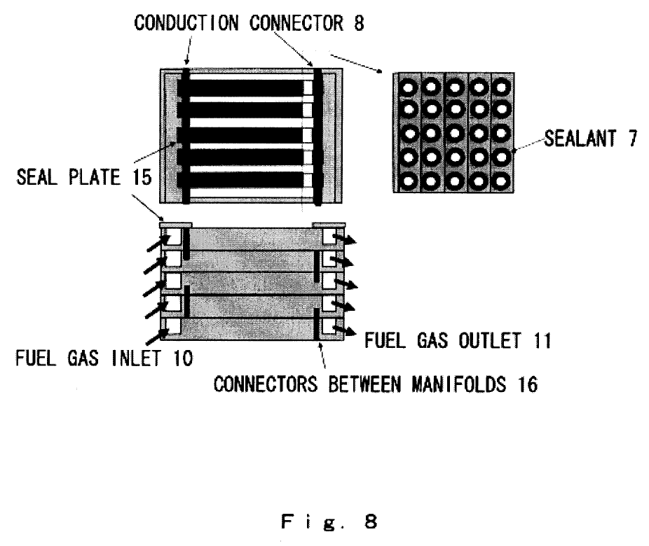

FIG. 9 shows an example of stacking using the manifold shown in FIG. 6 (stainless steel or other material);

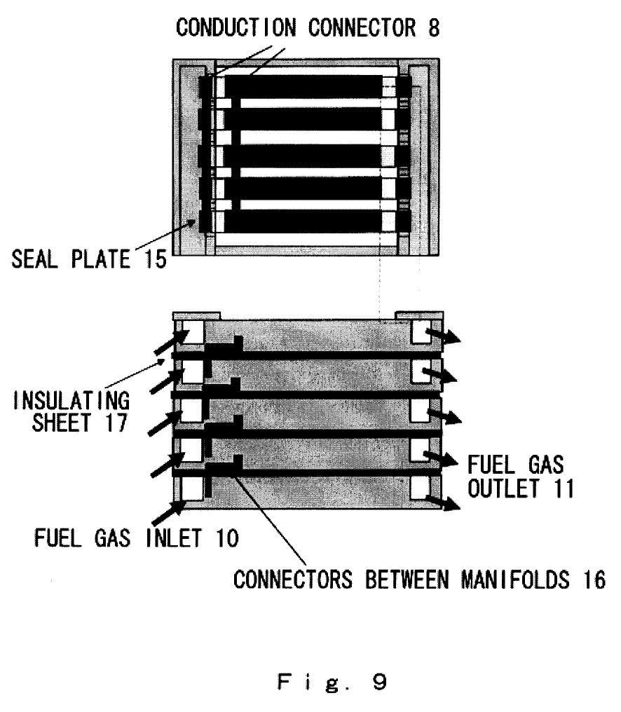

FIG. 10 shows an example of stacking using the manifold shown in FIG. 7 (ceramic or other material);

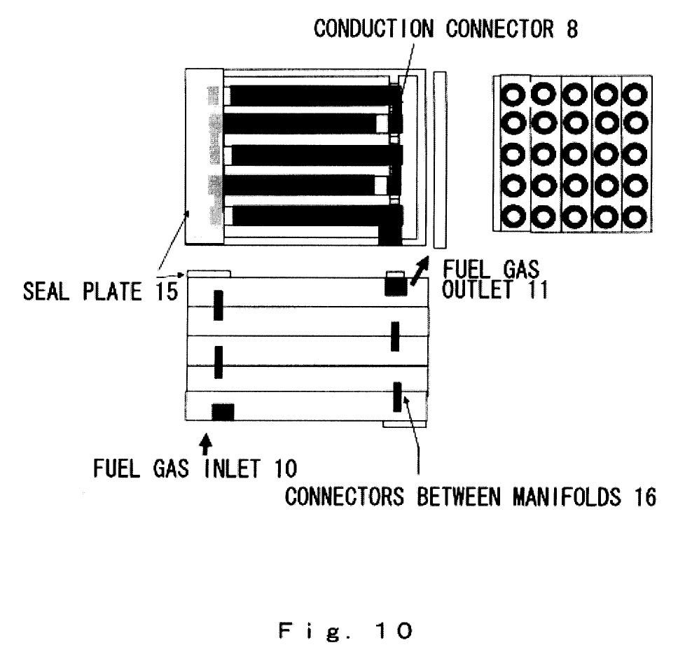

FIG. 11 shows an examples of a method of manufacturing a tube-type electrochemical reactor cell;

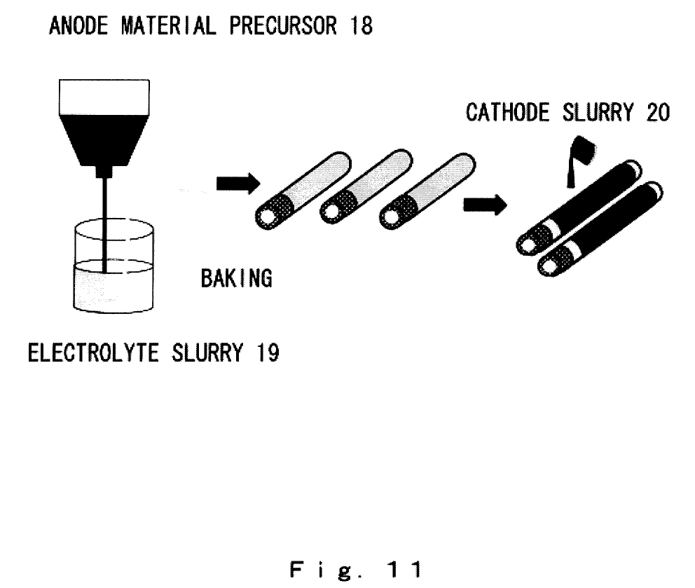

FIG. 12 shows an example of preparing an electrochemical reactor cell stack (parallel type);

FIG. 13 shows an example of a serially connected electrochemical reactor cell stack (parallel type); and

FIG. 14 shows an example of preparing an electrochemical reactor cell stack (serial type).

### BEST MODE FOR CARRYING OUT THE INVENTION

The present invention is explained in more detail below based on examples, but the present invention is not in any way limited by these examples.

### Example 1

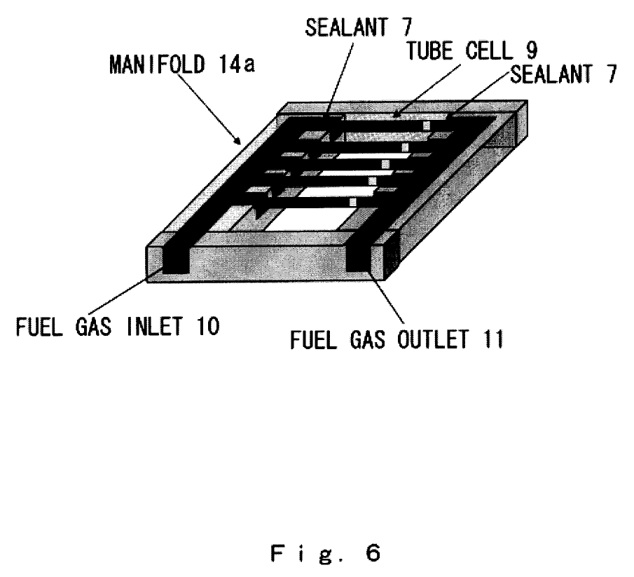

In this example, a tube-type electrochemical reactor cell was prepared by the following procedures (see FIG. 6). First, nitrocellulose was added as a binder to NiO (Wako) and a powder having a CeO₂-10 mol % Gd₂O₃ (GDC) composition (Anan Kasei), and this was kneaded with water to a clay consistency and formed into a tube-shaped molded body (anode tube) by extrusion molding. The resulting tube-shaped molded body had a diameter of 2 mm and a tube thickness of 0.5 mm (outer diameter 2 mm, bore 1 mm).

Next, the opening at one end of the resulting tube-shaped molded body was sealed with vinyl acetate, and this tube was dipped in slurry comprising a solid electrolyte with a GDC composition to dip coat it with an electrolyte layer-forming layer and obtain an electrolyte-coated molded tube. 5 mm at the other end of the porous anode tube was left bare, forming the exposed anode part.

Next, this molded tube was dried and baked for 6 hours at 1450° C. to obtain an electrolyte-coated anode tube coil. A paste comprising LaSrCoFeO₃ (Japan Ceramics) and the electrolyte material GDC in a container was applied as the cathode material to the electrolyte layer, dried at 100° C., and baked for 1 hour at 1000° C. A tube-type electrochemical reactor cell was obtained in this way. The completed cell had a tube diameter of 1.6 mm and a tube thickness of 0.4 mm.

### Example 2

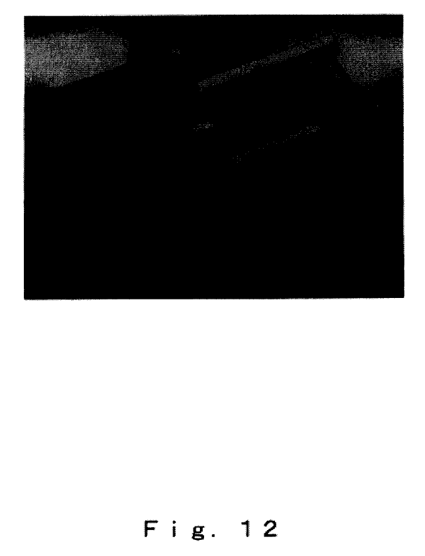

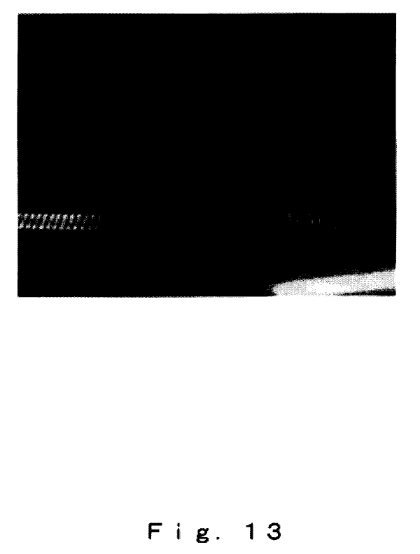

The tube cells obtained in Example 1 were arranged in parallel and connected to a gas introduction pipe (fuel introduction pipe) (FIG. 12). The connections were sealed with glass paste to fix the tube-type cells to the gas introduction pipe. Electrodes for current collection were attached by applying silver paste to the gas introduction pipe and the tube cell ends. The two units in FIG. 12 each have conductive connectors attached symmetrically, thus allowing easy serial connection between these units when they are superimposed as shown in FIG. 13.

### Example 3

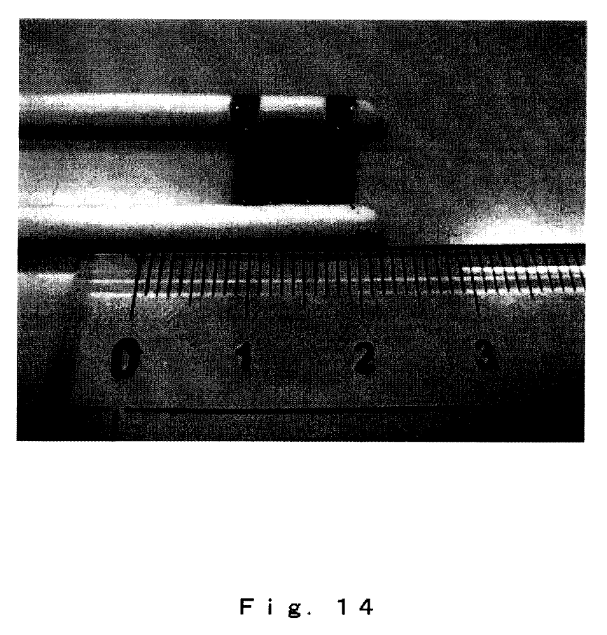

The tube cells obtained in Example 1 were connected to a gas introduction pipe with adjacent cells reversed (FIG. 14). The connections were sealed with glass paste to fix the tube-type cells to the gas introduction pipe. The tubes could then be serially connected by applying silver paste to the gas introduction pipe and tube cell ends in order to electrically connect adjacent tubes to one another. FIG. 14 shows a stack of four serially connected tube cells. 3.6 to 4 V of electrical output can be obtained with these four tube cells.

Embodiments of the present invention were explained in detail above, but the present invention is not limited to these embodiments, and various modifications are possible to the extent that the intent of the invention is not violated. For example, in these embodiments the examples all involve single units or stacks, but the same procedures could be followed to construct a structure of superimposed stacks.

### INDUSTRIAL APPLICABILITY

As discussed above, the present invention relates to a tube-type electrochemical reactor cell stack and an electrochemical reactor system composed of this stack, and a high-performance SOFC can be obtained with the tube-type electrochemical reactor cell stack of the present invention by efficiently stacking microtube-type ceramic reactors. This configuration allows low operating temperatures of 600° C. or less even using conventional materials, thereby making it possible to prepare and provide an electrochemical reactor cell stack and solid oxide fuel cell or other electrochemical system with excellent cost performance.

Moreover, using a manifold having both an efficient arrangement of tube-type cells and compact fuel gas introduction and exhaust parts allow the application of widely-used industrial processes, thereby providing a high-performance electrochemical reactor with reduced manufacturing costs. The present invention is useful because it provides new technologies and new products in connection with a new type of electrochemical reactor cell stack using tube-type cells, and a solid oxide fuel cell or other electrochemical reaction system using this electrochemical reactor cell stack.

1. An electrochemical reactor cell stack comprising a tube structure composed of an anode (fuel electrode), a dense ion conductor (electrolyte) and a cathode (air electrode), wherein (1) tube-type cells are arranged on a connecting part for connection located in the side of a fuel gas pipe, and (2) the respective tube-type cells are connected in parallel or series electrically.

2. The electrochemical reactor cell stack according to claim 1, wherein the tube-type cells are arranged on the connecting part of a manifold having a fuel gas introduction part, a fuel gas exhaust part and a connecting part for supporting the tube structure formed as a single unit.

3. The electrochemical reactor cell stack according to claim 2, wherein the manifold is made of a metal material.

4. The electrochemical reactor cell stack according to claim 2, wherein the manifold is made of a ceramic material.

5. The electrochemical reactor cell stack according to claim 2, wherein the respective tube-type cells are arranged so as to be connected in parallel or series electrically to the manifold.

6. The electrochemical reactor cell stack according to claim 2, wherein a gas conduit with an introduction part and exhaust part for the fuel gas is formed by stacking adjacent manifolds.

7. A manifold for an electrochemical reactor cell stack comprising a tube structure composed of an anode (fuel electrode), a dense ion conductor (electrolyte) and a cathode (air electrode), wherein a fuel gas introduction part, a fuel gas exhaust part and a connecting part for supporting the tube structure are formed as a single unit.

8. An electrochemical reactor cell stack module comprising the manifolds according to claim 3 stacked with insulating sheets therebetween, wherein each manifold is connected by means of a connector.

9. An electrochemical reactor stack module comprising the manifolds according to claim 4 stacked, wherein each manifold is connected by means of a connector.

10. An electrochemical reactor system for deriving current from an electrochemical reaction comprising the electrochemical reactor cell stack according to any one of claims 1 through 6, wherein the reactor system has an operating temperature of 650° C. or less.

11. The electrochemical reactor system according to claim 10, wherein the electrochemical reactor system is an electrochemical reactor for a solid oxide fuel cell or for waste gas purification, hydrogen production or synthetic gas production.
